(19) United States
(12) Patent Application Publication
(10) Pub. No.: US 2004/0068450 A1
(43) Pub. Date: Apr. 8, 2004

(54) Demand-controlled logistical system and a method for monitoring a demand-controlled logistical system

(76) Inventors: Ludwig Heilmann, Pinzberg (DE); Hans-Ludwig Helldorfer, Mohrendorf (DE); Michael Holzschuh, Hirschaid (DE)

Correspondence Address: SCHIFF HARDIN, LLP, PATENT DEPARTMENT, 6600 SEARS TOWER, CHICAGO, IL, 60606-6473, US

(21) Appl. No.: 10/416,675

(22) PCT Filed: Nov. 9, 2001
(86) PCT No.: PCT/DE01/04216

(30) Foreign Application Priority Data
Nov. 13, 2000 (DE) 100 56 217.5

(51) Int. Cl. G06F 17/60

(52) U.S. Cl. 705/28

(57) ABSTRACT

The invention relates to a demand-controlled logistical system, comprising a video camera arrangement (4), recording an area (1) for delivery units (2) at a supplier, whereby the image of said area (1) provides corresponding data, which may be transmitted by means of a data connection, preferably the internet (10), to the supplier for representation on a display unit (11).

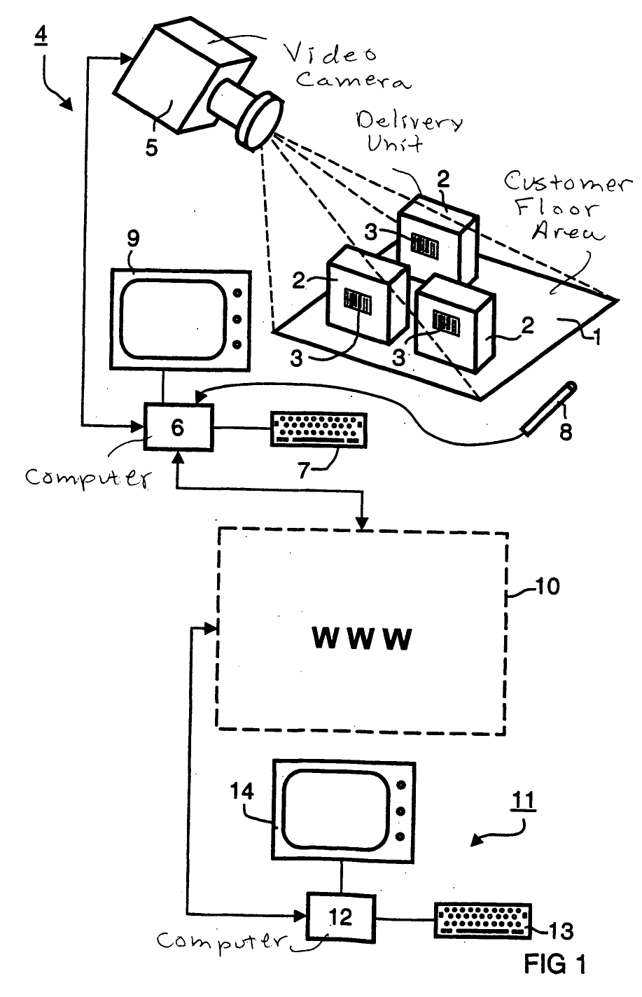

The invention is directed to a demand-controlled logistics system and to a method for monitoring a demand-controlled logistics system.

Such logistics systems that, for example, have become known by the name of “Kanban logistics” are based thereon that, for the sake of an optimally low warehousing, a supplier always delivers one or more delivery units onto a floor space located at a consumer whenever the stock of delivery units has dropped below a specific minimum value.

The delivery units can, for example, be a matter of entire assemblies, individual component parts or packaging units of component parts or components. A subsequent delivery is triggered in that the consumer requests a subsequent delivery from the supplier in a suitable way, for example by sending a fax message.

It is thereby disadvantageous for the supplier that the supplier only receives information about the stock of delivery units on hand at a consumer when the stock has dropped below the minimum stock.

EP 1 030 521 A1 discloses that, for example, the contents of a refrigerator be recorded with a video camera arrangement and that the image of the contents or data derived therefrom be transmitted to the user of the refrigerator in order to place the user in the position of making potentially required purchases.

The invention is based on the object of designing a logistics system of the species initially cited such that it becomes possible for a supplier to already obtain information about the actual stock of delivery units on hand at a consumer before the minimum stock has been reached. The invention is also based on the object of specifying a method for monitoring a demand-controlled logistics system.

This object is inventively achieved by a demand-controlled logistics system that comprises a video camera arrangement that records a floor space for delivery units allocated to a supplier and outputs data corresponding to the image of the floor space to proceed to the supplier via a data line for presentation on a display unit.

In the invention, thus, the supplier always has the opportunity to obtain information about the number of delivery units present thereat on the basis of the image of the floor space.

The invention also enables a simplification for the consumer since reviews of stock on hand and notifications to the supplier can be eliminated.

The invention also enables a simplification for the consumer since reviews of stock on hand and notifications to the supplier can be eliminated.

According to a preferred embodiment of the invention, the data line is at least partly formed by the Internet, so that no involved measures for setting up a data line between supplier and the video camera arrangement are required.

According to further preferred embodiments, the video camera arrangement comprises a video camera connected to a computer, particularly a personal computer (PC), whereby this is preferably what is referred to as a web camera (webcam). The realization of the video camera arrangement thus involves no particular outlay. Moreover, an especially suited hardware configuration exists when the data transmission is to ensue via the Internet.

It will suffice in many instances when a still image is transmitted as image.

The updating of the still image that is required in this case can ensue at defined, preferably adjustable time intervals, whereby the time intervals are to be selected on a case-by-case basis and can lie on the order of magnitude of hours through days. According to a further modification of the invention, however, the video camera arrangement can comprise actuation means upon whose actuation an updating of the still image ensues. It is then possible to activate the actuation means every time a delivery unit is removed and to thus see to it that the still image respectively reflects the current situation.

In the simplest case, the actuation means can be an input means, for example the keyboard or the mouse of a computer belonging to the video camera arrangement.

According to an especially preferred embodiment of the invention, however, the actuation means can be formed by a read device for data carriers provided at the delivery units, for example by a bar code reader and bar code labels. In this case, the data carrier is read when a delivery unit is removed from the floor space and the still image is updated at the end of the read event.

In order to be able to eliminate doubts in those instances wherein the supplier has doubts about the current nature of the still image, it is provided according to one modification of the invention that the display unit comprises actuation means upon whose actuation an updating of the still image ensues. This can be especially simply realized when the display unit comprises a computer with display device that is preferably fashioned as personal computer (PC).

That part of the object relating to a method is inventively achieved by a method for monitoring a floor area allocated to a supplier involved in a demand-controlled logistics system comprising the method steps that the floor area is recorded with a video camera arrangement, and that output data of the video camera arrangement corresponding to the image of the floor area are transmitted to the supplier via a data line and presented thereat on a display unit. According to modifications of the invention, the image of the floor area is respectively updated after removal of a delivery unit and transmitted to the supplier, preferably in response to actuation of a corresponding actuation means of the video camera arrangement.

An exemplary embodiment of the invention is shown in the attached, highly schematic FIGURE, partly in the fashion of a block diagram.

The FIGURE illustrates a demand-controlled logistics system, whereby a floor area 1 that is situated at the consumer (at that is shown much smaller in the FIGURE than it actually is) is allocated to a supplier, the delivery units 2 supplied by the supplier being placed thereon.

When respectively needed, a delivery unit is removed from the floor area 1 and supplied to a production line wherein the respective deliver unit 2 or, respectively, the contents thereof is required.

The delivery units 2 are respectively provided with a bar code label 3 as data carrier that contains data identifying the respective delivery unit 2.

The floor area 1 is monitored with a video camera arrangement referenced 4 overall. The video camera device comprises a video camera 5 and a computer 6 to which a keyboard 7, a bar code reader pen 8 a read device for the bar code labels 3 and a display device, for example a monitor 9, are connected. The computer 6 is a traditional personal computer (PC) and the video camera 5 is a video camera of the type commercially available as “webcam”.

The video camera arrangement 5 is connected to a display unit situated at the supplier and referenced 11 overall, being connected thereto via a data line that is at least partly formed by the Internet (WWW) referenced 10.

The display unit 11 is a matter of a computer 12, particularly a personal computer (PC) with connected keyboard 13 and display device, for example a monitor 14.

Thanks to the connection of the video camera arrangement 4 to the display device 11 via the Internet 10, there is thus the possibility of transmitting an image of the floor area 1 recorded with the video camera 5 to the supplier, so that the supplier is in the position of recognizing how many delivery units 2 are currently still situated on the floor area 1 and of deciding whether it is advisable to delivery new delivery units 2 to the floor area 1.

Even though it is fundamentally possible, it is not a live image of the floor area 1 but a still image of the floor area 1 that is transmitted in the preferred operating mode of the described logistics system. This still image is updated at defined time intervals, whereby the time intervals can be set by means of a corresponding input with the keyboard 7.

In order to enable an updating of the still image that is independent of the time duration that has been respectively set, the still image can to [sic] be updated by a corresponding actuation of the keyboard 7 of the video arrangement 4, which then functions as actuation means.

Over and above this, it is provided that the bard code reader en 8 reads the bar code label 3 of the removed delivery unit 2 whenever a delivery unit 2 is taken from the floor area 1 in order to be delivered to the respective production line. Triggered by this read event, on the one hand, the video camera arrangement 4 updates the still image that is supplies.

The transmission of the respectively updated still image and, as warranted, of the data read from a bar code label 3 to the supplier ensues, for example, as a data attachment of an e-mail indicating the updating of the still image.

By applying what is referred to as push technology, there is also the alternative possibility of notifying the supplier of updating of the still image and, potentially, of the presence of new [. . .] from bar code label 3 data that have been read [sic]. Insofar as the supplier agrees with a corresponding question, the updated still image and potentially appertaining data are then automatically transmitted to the supplier and presented on the display unit 11.

Measures such as e-mails and the application of push technology can, of course, be omitted when a continuous connection of the video camera arrangement 4 with the display unit 11 is maintained via the Internet 10. In the invention, thus, the supplier is provided with the opportunity of keeping current regarding the number of delivery units 2 present on the floor area 1.

In the described exemplary embodiment, the supplier himself also has the possibility of updating the still image with a corresponding actuation of the keyboard 13 of the display unit 11, which then functions as actuation means. In this case, a corresponding message is sent to the video camera arrangement 4 that, when this function is enabled, starts a small application (applet) on the computer 6 of the video camera arrangement 4 that effects the updating of the still image.

In the described exemplary embodiment, the data transmission between video camera arrangement 4 and display unit 11 ensues at least partly via the Internet. This is not compulsory within the scope of the invention. On the contrary, the data transmission can also ensue in some other way, for example via WAN (wide area network) or LAN (local area network). The fashioning of the video camera arrangement 4 and/or display unit 11 can also deviate from the described exemplary embodiment.

1. Demand-controlled logistics system, comprising a video camera arrangement (4) that records a floor area (1) for delivery units (2) allocated to a supplier and outputs data corresponding to the image of the floor area (1) that proceed to the supplier via a data line (10) for presentation on a display unit (11).

2. Logistics system according to claim 1, whereby the data line (10) is at least partly formed by the Internet (WWW).

3. Logistics system according to claim 1 or 2, whereby the video camera arrangement (4) comprises a video camera (5) connected to a computer (6).

4. Logistics system according to claim 3, whereby a personal computer (PC) is provided as computer (6).

5. Logistics system according to claim 3 or 4, whereby a web camera (webcam) is provided as video camera (5).

6. Logistics system according to one of the claims 1 through 5, whereby a still image is transmitted as image.

7. Logistics system according to claim 6, whereby an updating of the still image ensues updated [sic] at defined, preferably adjustable time intervals.

8. Logistics system according to claim 6 or 7, whereby the video camera arrangement (4) comprises actuation means (7) upon whose actuation an updating of the still image ensues.

9. Logistics system according to one of the claims 6 through 8, whereby the display unit (11) comprises actuation means (13) upon whose actuation an updating of the still image ensues.

10. Logistics system according to claim 9, whereby the actuation means respectively comprise a data carrier (3) for data identifying the delivery unit (2) that is attached to the individual delivery units (2) and a read device for the data carrier that is connected to the display device (11).

11. Logistics system according to one of the claims 1 through 10, whereby the display unit (11) comprises a computer (12) with display device (14).

12. Logistics system according to claim 11, whereby a personal computer (PC) is provided as computer (12).

13. Method for monitoring a floor area (1) for delivery units (2) allocated to a supplier involved in a demand-controlled logistics system, comprising the method steps that the floor area (1) is recorded with a video camera arrangement (4) and that output data of the video camera arrangement (4) corresponding to the image of the floor area (1) are transmitted to the supplier via a data line (10) and are presented on a display unit (11) thereat.

14. Method according to claim 13, whereby the image of the floor area (1) is at least respectively updated after removal of a delivery unit (2) and is transmitted to the supplier.

15. Method according to claim 14, whereby a corresponding actuation means (7) of the video camera arrangement (4) is actuated for the updating of the image.
